(19) United States
(12) Patent Application Publication
(10) Pub. No.: US 2007/0082210 A1
(43) Pub. Date: Apr. 12, 2007

(54) Method for providing fog-free goggle lenses

(76) Inventor: Robert Frediani, Milwaukee, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/244,833

(22) Filed: Oct. 6, 2005

(51) Int. Cl. B32B 27/00

(52) U.S. Cl. 428/500

(57) ABSTRACT

An anti-fog composition can be applied underwater to a transparent surface, such as the lens of a diving mask. The composition comprises at least one sodium salt of a fat, oil, or fatty acid. The composition may be conveniently applied underwater by means of an applicator comprising a tube to store the composition and a rotatable screw to drive the composition out of, or back into, the tube.

### BACKGROUND OF THE INVENTION

A reoccurring problem during scuba diving is the fogging up of the mask caused by condensation of water vapor on the inside surface of the mask lens. Such mask fogging obscures the diver's vision and consequently can be both a nuisance and a safety hazard. Numerous compositions have been developed that can be applied to the make lens prior to diving in order to prevent the occurrence of fogging. However, these compositions are not permanent and often wear off the mask during the dive thereby allowing the mask to fog up. As these compositions can only be applied out of the water, the diver is forced to surface and remove the mask and reapply the anti-fog coating. The necessity of resurfacing during the dive significantly reduces the length of time the diver can spend at the desired dive depth.

Therefore, provision of an anti-fogging composition that can be applied under water during the dive would provide substantial benefits to the diving industry.

### BRIEF SUMMARY OF THE INVENTION

In a preferred embodiment, the invention is a method for preventing underwater fogging of an article, the method comprising of at least one optically transparent surface, wherein the article is submerged in water; and, applying a composition to at least a portion of the optically transparent surface while the article is submerged in water, wherein the composition comprises at least one sodium salt of a fat, oil, or fatty acid.

In another preferred embodiment, the invention relates to an application system comprising a tube having a first open end, a second open end, and an inside wall; a plug inserted into the second open end of the tube and rotationally engaged with the inside wall of the tube, wherein the plug is adapted to retain a paste within the tube; a threaded rod or screw attached to, or integral with, the plug and extending axially through at least a portion of the tube, wherein the threaded rod or screw is not rotatable in relation to the plug; a rotatable boss, connected to or integral with, the plug and adapted to rotate the plug is relation to the tube; and a mass comprising a composition that comprises at least one sodium salt of a fat, oil, or fatty acid, wherein at least a portion of the mass is located within the tube in contact with the inside wall of the tube and with the threaded rod or screw; wherein rotation of the plug rotates the threaded rod or screw within the mass thereby moving the mass selectively toward or away from the first open end of the tube.

In yet another preferred embodiment, the present invention is a method to produce an applicator for an anti-fog composition, the method comprising: heating water; adding at least one sodium salt of a fat, oil, or fatty acid to the water and blending to form a paste; maintaining the paste at a temperature sufficient to prevent solidification of the paste; loading the non-solidified paste into a storage chamber of an applicator; and allowing the loaded paste to cool to a temperature sufficiently low to permit solidification of the paste within the chamber.

More particularly, the present invention relates to compositions that can be applied underwater to a mask lens with a suitable applicator.

### BRIEF DESCRIPTION OF THE DRAWINGS

FIG. 1 is a front view of an under water no-fog applicator.

FIG. 2 is a bottom view of the applicator of FIG. 1.

FIG. 3 is a side view of the applicator of FIG. 1.

FIG. 4 is an elevated perspective view of the applicator of FIG. 1.

### DETAILED DESCRIPTION OF THE PREFERRED EMBODIMENT

No fog composition suitable for underwater application comprises an aqueous paste of sodium salt of fat, oils, and/or fatty acids. Suitable sodium salts are those used in the soap and cosmetic industry, more preferably, sodium tallowate (CAS 008052-48-0), sodium cocoate (CAS 061789-31-9), and sodium palm kemelate (CAS 061789-89-7). The water content in the paste can be adjusted as desired to obtain the desired composition consistency and product characteristics. Too little water in the paste will result in a relatively hard composition consistency which may make application of the composition to a lens more difficult. More water in the paste will make the consistency softer but may decrease the durability of the product underwater after it has been applied. Generally, the durability of the product increases the time after production. Although not wishing to be bound by the theory, the Applicant believes that the increase in durability may be due to the reduction in moisture in the product over time. A convenient weight ratio of the ingredients is about 2 parts water/about 1 part sodium fatty acid salt. The fatty acid salts may be a blend of one or more fatty acids, fats or oils.

The following example illustrates a preferred embodiment of the composition and a preferred embodiment of a method to make the composition. Six parts by weight water is heated to nearly boiling. Preferably the heat is applied indirectly, such as through use of a double boiler. One part by weight each of sodium tallowate, sodium cocoate, and sodium palm kemelate are then added to the heated water. Preferably, the solid sodium fatty acid salts are either granulated or grated or otherwise finely divided prior to addition to the water. After addition to the water the mixture is stirred constantly until the solids are dissolved and a paste consistency is achieved. The composition can then be kept warm until loaded into an applicator. The best results are obtained by allowing the composition to cool or solidify approximately 24 to 48 hours prior to using as an anti-fog agent. The composition of this preferred embodiment has been demonstrated to produce a no-fog effect down to at least 70 feet under water.

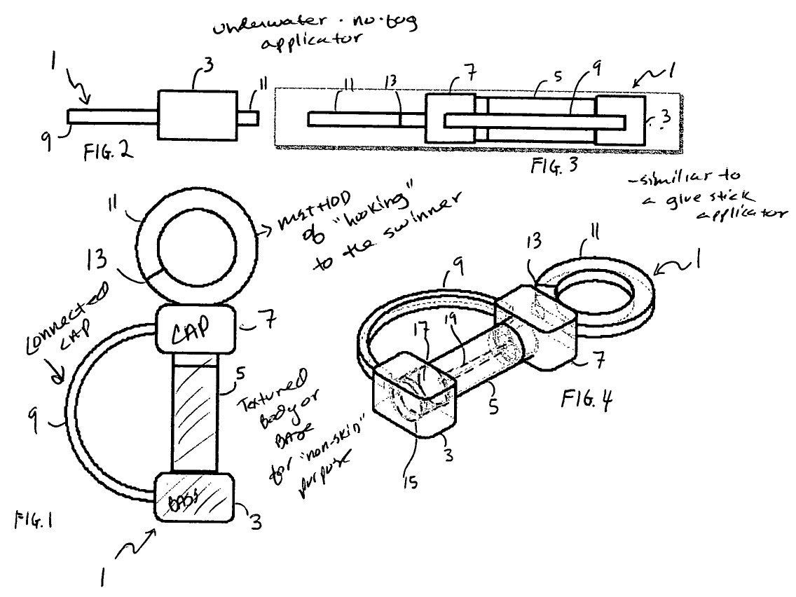

A suitable apparatus for applying the no-fog composition underwater is shown in FIGS. 1-4, which illustrate a front, bottom, side, and elevated perspective view, respectively. The applicator 1 comprises a boss 3, a tube 5 for holding the composition and a cap 7 for sealing the tube. Both boss 3 and cap 7 should provide water-tight seals for the tube in order to prevent water from over-saturating the composition. Preferably, the cap and the boss are connected to each other by means of strap 9. Strap 9 may be a plastic band, a string, a chain, or other suitable connecting means.

In order to prevent loss of the applicator during the dive, means are providing for hooking the apparatus to the swimmer. In the embodiment shown, the means are a ring 11 having a cut 13 through the ring. The ring 11 may be flexed such that cut 13 opens to allow the ring to be inserted over or through a loop or ring otherwise attached to the swimmer.

As shown in FIG. 4, boss 3 has a retention ring 15 to hold tube 5 in a rotatable relationship to the boss 3. A plug 17 extends from the boss into tube 5 to form a bottom of tube 5 to contain the no-fog composition. A threaded rod 19 extends from plug 17 axially through tube 5. Rotation of boss 3 results in the rotation of plug 17 and threaded rod 19 in relationship to tube 5. Such rotation drives the paste-like composition either out through the cap end of tube 5 or retracting back into tube 5. This applicator functions similarly to glue stick applicators, lipstick applicators and lip balm applicators, and as such, is familiar in the art.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method for preventing underwater fogging of an article, the method comprising:
providing an article comprising at least one optically transparent surface, wherein the article is submerged in water; and,
applying a composition to at least a portion of the optically transparent surface while the article is submerged in water, wherein the composition comprises at least one sodium salt of a fat, oil, or fatty acid.

2. The method of claim 1 wherein the article is a diving mask.

3. The method of claim 1 wherein the transparent surface is a lens.

4. The method of claim 1 wherein sodium salt is at least one of sodium tallowate, sodium cocoate, or sodium palm kernelate.

5. The method of claim 1 wherein the composition is applied by means of an applicator.

6. The method of claim 6 wherein the applicator comprises a tube having a first open end, a second open end, and an inside wall.

7. The method of claim 1 wherein the composition further comprises water.

8. The method of claim 7 wherein the composition comprises about 2 parts water and 1 part sodium salt.

9. An application system comprising:
a tube having a first open end, a second open end, and an inside wall;
a plug inserted into the second open end of the tube and rotationally engaged with the inside wall of the tube, wherein the plug is adapted to retain a paste within the tube;
a threaded rod or screw attached to, or integral with, the plug and extending axially through at least a portion of the tube, wherein the threaded rod or screw is not rotatable in relation to the plug;
a rotatable boss, connected to or integral with, the plug and adapted to rotate the plug in relation to the tube; and
a mass comprising a composition that comprises at least one sodium salt of a fat, oil, or fatty acid, wherein at least a portion of the mass is located within the tube in contact with the inside wall of the tube and with the threaded rod or screw;
wherein rotation of the plug rotates the threaded rod or screw within the mass thereby moving the mass selectively toward or away from the first open end of the tube.

10. The system of claim 9 further comprising a cap removably attached to cover the first open end of the tube.

11. The system of claim 10 wherein the cap is connected to the boss.

12. The system of claim 9, further comprising means to attach the applicator to a driver.

13. The system of claim 12 wherein the means to attach is a ring connected to the apparatus.

14. The system of claim 9 wherein the sodium salt is at least one of sodium tallowate, sodium cocoate, or sodium palm kernelate.

15. A method to produce an applicator for an anti-fog composition, the method comprising:
heating water;
adding at least one sodium salt of a fat, oil, or fatty acid to the water and blending to form a paste;
maintaining the paste at a temperature sufficient to prevent solidification of the paste;
loading the non-solidified paste into a storage chamber of an applicator; and
allowing the loaded paste to cool to a temperature sufficiently low to permit solidification of the paste within the chamber.

16. The method of claim 15 wherein the sodium salt is at least one of sodium tallowate, sodium cocoate, or sodium palm kernelate.

17. The method of claim 15 wherein the loaded paste is allowed to cool at least about 24 to 48 hours prior to using as an anti-fog agent.

18. The method of claim 15 wherein the applicator comprises a tube having a first open end, a second open end, and an inside wall.
